(19) United States
(12) Patent Application Publication
(10) Pub. No.: US 2026/0080287 A1
(43) Pub. Date: Mar. 19, 2026

(54) QUANTUM CIRCUIT FOR IMPLEMENTING AN ORACLE AND METHODS FOR USE THEREWITH

(71) Applicant: BEIT Sp. z o.o., Krakow (PL)

(72) Inventor: Akos Nagy, Toronto (CA)

(73) Assignee: BEIT Sp. z o.o., Krakow (PL)

(21) Appl. No.: 19/179,095

(22) Filed: Apr. 15, 2025

Related U.S. Application Data
(60) Provisional application No. 63/646,089, filed on May 13, 2024.
(60) Provisional application No. 63/647,129, filed on May 14, 2024.

(51) Int. Cl. G06N 10/20; G06N 10/60

(52) U.S. Cl. CPC G06N 10/20; G06N 10/60

(57) ABSTRACT

A quantum circuit, configured to process n qubits and d additional qubits, includes: a d-qubit Quantum Fourier Transform circuit configured to apply a d-qubit Quantum Fourier Transform to the d additional qubits; a plurality of parity-fan-out gates controlled by the n qubits and configured to control the additional d qubits, wherein each of the plurality of parity fan-out gates is coupled to a corresponding one a plurality of sets of additional phase gates that also apply phase angles to the d additional qubits, wherein quantum circuit implements a unitary of a bit function and wherein the sets of additional phase gates apply the phase angles to the d additional qubits based on a Walsh-Hadamard Transform of a conversion of the bit function to a binary number, and a d-qubit Inverse Quantum Fourier Transform circuit configured to apply a d-qubit Inverse Quantum Fourier Transform to the d additional qubits.

### CROSS-REFERENCE TO RELATED APPLICATIONS

The present U.S. Utility patent application claims priority pursuant to 35 U.S.C. § 119(e) to U.S. Provisional Application No. 63/646,089, entitled “QUANTUM CIRCUIT FOR IMPLEMENTING AN ORACLE AND METHODS FOR USE THEREWITH”, filed May 13, 2024; and U.S. Provisional Application No. 63/647,129, entitled “QUANTUM CIRCUIT FOR IMPLEMENTING AN ORACLE AND METHODS FOR USE THEREWITH”, filed May 14, 2024, both of which are hereby incorporated herein by reference in their entirety and made part of the present U.S. Utility patent application for all purposes.

### BACKGROUND OF THE INVENTION

### Technical Field of the Invention

This invention relates generally to computer systems and particularly to quantum computing techniques and circuits.

### Description of Related Art

Computing devices are known to communicate data, process data, and/or store data. Such computing devices range from wireless smart phones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a block diagram of an example of a quantum computing architecture;

FIG. 1B is a block diagram of an example of a quantum oracle;

FIG. 2A is a block diagram of an example of a quantum oracle;

FIG. 2B is a block diagram of an example of a parity-fan-out gate;

FIG. 2C is a block diagram of an example of a quantum oracle;

FIG. 2D is a block diagram of an example of a parity-fan-out gate; and

FIG. 3 is a flow diagram of an embodiment of a method in accordance with the present invention.

### DETAILED DESCRIPTION OF THE INVENTION

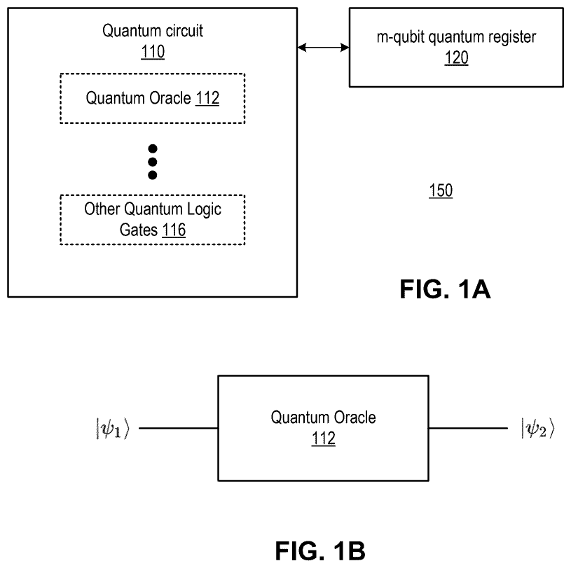

FIG. 1A is a block diagram of an example of a quantum computing architecture. In particular, a quantum circuit 110 is presented that includes one or more quantum oracles 112, and/or one or more other quantum logic gates 116 that operate on m qubits of a quantum register 120. The quantum oracle 112, which may also be referred to as “oracle operator”, “oracle function” or simply “oracle” is a black box that performs a quantum operation on an input quantum state either with, or without, the aid of additional ancillas. In various examples, the action of the quantum oracle 112 on a specific quantum state can be found by multiplying an input vector, which represents the input qubit state, by the unitary matrix U_{ƒ} (or simply “unitary”) representing the particular function being implemented. The result is a new quantum vector state. As shown in FIG. 1B, the input vector state can be represented by:

|ψ₁

[symbol]

And the output vector state can be represented by:

|ψ₂

[symbol]

Quantum oracles can play a fundamental role in quantum algorithms by providing a way to manipulate quantum states and perform computations that are not possible with classical computers. Quantum oracles are particularly relevant in the context of quantum algorithms like Grover's algorithm and Shor's algorithm. These algorithms use quantum oracles to solve problems more efficiently than classical algorithms. In Grover's algorithm, the quantum oracle is used to mark the solutions of a search problem. It applies a phase flip to the marked states, which amplifies their amplitude and allows for a more efficient search. In Shor's algorithm, the quantum oracle is used as a subroutine to find the period of a function. This is a crucial step in factoring large numbers, which is the basis for breaking many classical encryption schemes.

Furthermore, consider the following constructs for a quantum oracle 112 operating on a binary function.

Below [symbol] ₂:={0,1}. Given a binary function,

$$f : {𝔽}_{2}^{n} \to {F}_{2}^{d} ,$$

oracles that act on n+d qubits as

$${{{{{U}_{f} \vert x 〉}_{n} \vert y 〉}_{d} = \vert x 〉}_{n} \vert f ( x ) 〉}_{d} , \qquad ( 0.1 )$$

are called quantum dictionary encoders or data-access oracles. Here the [symbol] symbol represents some kind of addition on [symbol] . More generally, oracles that act on n+d qubits as

$${{{{{U}_{f} \vert x 〉}_{n} \vert y 〉}_{d} = {e}^{i {α}_{f , x , y}} \vert x 〉}_{n} \vert y f ( x ) 〉}_{d} , \qquad ( 0.2 )$$

are called projective quantum dictionary encoders or projective data-access oracles.

In particular, a data-access oracle is a theoretical construct that allows a quantum algorithm to interact with a classical or quantum database. It provides access to the data stored in the database and allows for efficient queries or operations on the data. In the context of quantum algorithms, data-access oracles are used to solve problems such as search or database-related tasks. A projective data-access oracle is a specific type of data-access oracle that uses projective measurements to access the data. Projective measurements in quantum mechanics involve collapsing the quantum state of a system into one of the eigenstates of the measured observable. In the context of a projective data-access oracle, the measurement outcomes correspond to the values stored in the database, allowing the algorithm to obtain the desired information. quantum dictionary encoder that is used to encode classical data into a quantum state in a way that preserves the structure of a dictionary. A dictionary is a data structure that stores key-value pairs. Quantum dictionary encoders allow for efficient storage and retrieval of information in a quantum setting. Projective quantum dictionary encoders combine the concepts of projective measurements and quantum dictionary encoders. These encoders use projective measurements to retrieve the values associated with specific keys in a quantum dictionary. By performing measurements on the encoded quantum state, the projective quantum dictionary encoder can extract the desired information.

In various examples, the quantum oracle 112 is implemented via a quantum circuit that includes:
a d-qubit Quantum Fourier Transform circuit configured to apply a d-qubit Quantum Fourier Transform to the d additional qubits;
a plurality of parity-fan-out gates controlled by the n qubits and configured to control the additional d qubits, wherein each of the plurality of parity fan-out gates is coupled to a corresponding one a plurality of sets of additional phase gates that also apply phase angles to the d additional qubits, wherein quantum circuit implements a unitary of a bit function and wherein the sets of additional phase gates apply the phase angles to the d additional qubits based on a Walsh-Hadamard Transform of a conversion of the bit function to a binary number, and
a d-qubit Inverse Quantum Fourier Transform circuit configured to apply a d-qubit Inverse Quantum Fourier Transform to the d additional qubits.

In addition or in the alternative to any of the foregoing, the quantum circuit further includes a first set of phase gates configured to apply, prior to the Quantum Fourier Transform circuit, first phase angles to the d additional qubits; and a second set of phase gates configured to apply, after the Inverse Quantum Fourier Transform circuit, inverses of the first phase angles to the d additional qubits.

In addition or in the alternative to any of the foregoing, the quantum circuit implements one of: a quantum dictionary encoder, a data-access oracle, a projective quantum dictionary encoder or a projective data-access oracle.

In addition or in the alternative to any of the foregoing, the first phase angles applied to the d additional qubits each correspond to a phase angle of −π/2^{j} for a jth one of the d additional qubits.

In addition or in the alternative to any of the foregoing, the plurality of parity-fan-out gates are each fan-out gates controlled by differing ones of the n qubits.

In addition or in the alternative to any of the foregoing, the plurality of parity-fan-out gates are each controlled by differing non-null subsets of the n qubits.

In addition or in the alternative to any of the foregoing, when one of the parity-fan-out gates is controlled by k of the n qubits, the one of the plurality of parity-fan-out gates is implemented using O(k+d) CNOT gates.

In addition or in the alternative to any of the foregoing, the conversion of the bit function to the binary number utilizes a modulo 2 addition.

In addition or in the alternative to any of the foregoing, the conversion of the bit function to the binary number utilizes a polynomial approximation of the bit function.

In addition or in the alternative to any of the foregoing, the quantum circuit is implemented without ancillas.

In addition or in the alternative to any of the foregoing, the quantum circuit is implemented via a plurality of ancillas initialized to a zero state.

The quantum circuits described herein improve the technology of quantum oracles by constructions, based on the Walsh-Hadamard Transform of another function,

$$\hat{f} : {𝔽}_{2}^{n} \to 2$$

derived from the binary function ƒ (see Appendix A). In this case [symbol] being the addition, modulo 2^{d}. These designs have similar worst case complexities as prior circuits and in certain cases it has significantly improved circuit depth and gate counts. Measures of complexity are Clifford+T gate count and Clifford+T gate depth. Furthermore, designs are presented that can be made shallower by adding ancillas, and without using swap gates. In the shallowest case, these oracle implementations can have a total depth of O(n+d)—using only CNOT, RZ rotations, and a single d-qubit Quantum Fourier transform. Consider the results for the methodologies below.

Method 1
no ancillas, generic function
$Given a binary function , f : {𝔽}_{2}^{n} \to {𝔽}_{2}^{d} , we construct a projective quantum dictionary encoder , {U}_{f} , for f on$
$n + d qubits , that is , for all x ∈ {𝔽}_{2}^{n} and y ∈ {𝔽}_{2}^{d} :$

| | |
|---|---|
| U_{f}\|x)ₙ\|ŷ [symbol] = e^{iα}^{_{f,x,y}}\|x [symbol] ₙ\|ŷ + \hat{f}(x) [symbol] . | (2) |

where
α_{f,x,y} = πi(1 − 2^{-d})(f(0) − f(x)).
The design uses only the following gates: Hadamard, controlled-NOT, R_{Z} rotations, and a single d-qubit
Quantum Fourier Transform and its inverse. The worst case complexities of this design are:

| | |
|---|---|
| Circuit depth | O(log₂(d)2ⁿ) |
| R_{Z} rotation depth | 2ⁿ |
| Clifford gate count | O(d2ⁿ) |
| R_{Z} rotation count | d2ⁿ |

Method 2
no ancillas, sparse Walsh-Hadamard Transform
$Given a binary function , f : {𝔽}_{2}^{n} - {𝔽}_{2}^{d} , such that {W}_{f} := \vert supp ( WH ( f ) ) \vert ⩽ {2}^{n} , the complexities of the oracle in$
equation (2) can be reduced to the following:

| | |
|---|---|
| Circuit depth | O(log₂(max(n, dⱼ)W_{f}) |
| R_{Z} rotation depth | W_{f} |
| Clifford gate count | O(dWⱼ) |
| R_{Z} rotation count | dW_{f} |

Remark 1.1. Before the next method, recall that

$${B}_{n , k} < 0.98 \cdot {2}^{{H}_{2} ( \frac{k}{n} ) n} ;$$

### cf. {2, Lemma 7.1}.

Method 3
one ancilla, bounded degree
$Let k < \frac{n}{2} and f : {𝔽}_{2}^{n} \to {𝔽}_{2}^{d} be a binary function , such that supp ( WH ( f ) ) contains no bitstrings of Hamming$
weight strictly between k and n − k.
Then the complexities of the oracle in equation (2) can be reduced to the following:

| | |
|---|---|
| Circuit depth | O(log₂(d)B_{n,k}) |
| R_{Z} rotation depth | O(B_{n,k}) |
| Clifford gate count | O(dB_{n,k}) |
| R_{Z} rotation count | O(dB_{n,k}) |

Method 4
d(2^{l} − 1) ancillas, generic function
$Given l ∈ ⌊ 1 , n ⌋ ⋂ and a binary function , f : {𝔽}_{2}^{n} \to {𝔽}_{2}^{d} , we construct a projective quantum dictionary encoder ,$
${U}_{f , l} , for f on n + d {2}^{l} qubits , that is , for all x ∈ {𝔽}_{2}^{n} and y ∈ {𝔽}_{2}^{d} :$
U_{f,l}|x)ₙ|ŷ [symbol] (|0 [symbol] ^{⊗(2}^{^{l}}⁻¹⁾) = e^{iα}^{_{f,x,y}}|x [symbol] ₙ|ŷ + \hat{f}(x) [symbol] (|0 [symbol] ^{⊗(2}^{^{l}}⁻¹⁾).
where
α_{f,x,y} = πi(1 − 2^{-d})(f(0) − f(x)).
The design uses only the following gates: Hadamard, controlled-NOT, R_{Z} rotations, and a single d-qubit
Quantum Fourier Transform and its inverse. The worst case complexities of this design are:

| | |
|---|---|
| Circuit depth | O((l + log₂(d)2^{n-l}) |
| R_{Z} rotation depth | 2^{n-l} |
| Clifford gate count | O(d2ⁿ) |
| R_{Z} rotation count | d2ⁿ |

As the worst case complexities are otherwise comparable, these methods provide, potentially more efficient, alternative, especially in for the class of functions with sparse Walsh-Hadamard transforms (see Method 2), and bounded polynomial degrees (see Method 3). These advantages come, in part, from the choice of decomposition. Compared with other methods, the methods above also use the modulo 2ⁿ addition in equation (1). This has clear advantages in many applications, for example, in binary optimization problems.

The further operation of the quantum oracle 112, including several designs, variations and optional functions and features is described in conjunction with the examples that follow.

### Example Designs

The classical preprocessing of the function (the data),

$$f : {𝔽}_{2}^{n} \to {F}_{2}^{d} ,$$

involves computing the Walsh-Hadamard transform,

$$WG ( f ) : {𝔽}_{2}^{n} \to ℤ ,$$

as in equation (4). This can be done classically via the Fast Walsh-Hadamard Transform in O(dn2ⁿ) time and O(dn) extra space.

In the design patterns below corresponding to Methods 1 and 2, we assume that a quantum circuit on n+d qubits can be in an arbitrary state. In Method 3 an ancilla initialized in the zero state is added. Bits and qubits are zero-indexed.

For each iϵ{1, . . . , 2^{μ}} let zᵢ be the i^{th} term of the n-bit Gray code and t(i)ϵ{0, 1, . . . , n−1} be the index of the corresponding the bit change.

Parity-fan-out gates are defined in Appendix B.

Design for Method 1

```
(1) Apply the d-qubit Quantum Fourier Transform to the last d qubits.
(2) Starting from i = 1 to i = 2ⁿ, do:
    (2/A) Apply a parity-fan-out gate controlled my the [symbol] (i)^{th} qubit and targeting the last d qubits.
    $( 2 / B ) For j ∈ \{ 0 , 1 , … , d - 1 \} , apply a phase gate with angle \frac{π}{\text{?}} WH ( f ) ( {z}_{i} ) to the {( n + j )}^{th} qubit .$
(3) Apply the d-qubit Inverse Quantum Fourier Transform to the last d qubits. [symbol]
indicates data missing or illegible when filed
```

Let z₁, z₂, . . . , z_{W}_{_{ƒ}} be any enumeration of supp(WH(ƒ)) and t_{ƒ}(i)⊂{0, 1, . . . , n−1} be the indices of the bit changes at the i^{th} step.

Design for Method 2

Same as for Method 1, except for step 2/A, which now reads:
(2/A) Apply a parity-fan-out gate controlled my the qubits labelled by
i_{f}(i) and targeting the last d qubits.

Let

$$k < \frac{n}{2}$$

and let z₁, z₂, . . . , z_{B}_{_{n,k}} be the enumeration of n-dimensional binary vectors with Hamming weight at most k, in a way that neighboring elements differ by at most two bits. Such codes exist [3]. Redefine i_{ƒ} accordingly. Let

$$Let ε := ( 1 , 1 , … , 1 ) ∈ {𝔽}_{2}^{n}$$

be the “all-one” bitstring. Note that h(z⊕E)=n−h(z).

Design for Method 3

```
Initialize the ancilla in the zero state and use a parity-fan-out gate controlled by all n nonancillas and
targeting the ancilla. After that repeat the design for Method 2, with the following two differences: [symbol]
    The order of components is the one given above. [symbol]
    Step 2 has three further substeps:
    (2/C) Apply a parity-fan-out gate, controlled my the ancilla and targeting the last d qubits.
    $( 2 / D ) For j ∈ \{ 0 , 1 , … , d - 1 \} , apply a phase gate with angle \frac{π}{\text{?}} WH ( f ) ( {z}_{i} ⊕ E ) to the {( n + j )}^{th} qubit .$
    (2/E) Apply a parity-fan-out gate, controlled my the ancilla and targeting the last d qubits. [symbol]
indicates data missing or illegible when filed
```

In the design pattern below corresponding to Method 4, we assume that a quantum circuit on n+d2^{l} qubits is given. The first n+d qubits may be in an arbitrary state, but the last d(2^{l}−1)d qubits start in the all-zero state.

Design for Method 4

```
(1) Apply the d-qubit Quantum Fourier Transform to the qubits starting from n to n + d.
(2) Apply the A_{l,d} gate from equation (5), controlled by the first l qubits and targeting the last d2^{l}
    qubits.
$( 3 ) For all i ∈ \{ 0 , 1 , … , {2}^{l} - 1 \} and j ∈ \{ 0 , 1 , … , n - 1 \} , apply a phase gate with angle \frac{π}{\text{?}} WH ( f ) ( {z}_{i} ) to the$
    (n + 1 · d + j)^{th} qubit.
(4) Starting from k = 1 to k = 2ⁿ⁻¹ − 1, do:
    (5/A) Apply a parity-fan-out gate controlled by the [symbol] (k)^{th} qubit and targeting the last d2^{l} qubits.
    (5/B) For all i ∈ {0, 1 .... , 2^{l} − 1} and j ∈ (0, 1, .... , n − 1}, apply a phase gate with angle
        $\frac{π}{\text{?}} WH ( f ) ( {z}_{k {2}^{i} + i} ) to the {( n + i \cdot d + j )}^{th} qubit .$
(5) Apply the inverse of the A_{l,d} gate controlled by the first l qubits and targeting the last d2^{l} qubits.
(6) Apply the d-qubit Inverse Quantum Fourier Transform to the qubits starting from a to n + d. [symbol]
indicates data missing or illegible when filed
```

Remark 2.1. In all the above designs:
When

$$supp ( WH ( f ) ) = {𝔽}_{2}^{n} ,$$

Method 2 recovers Method 1.
When l=1, Method 4 recovers Method 1.
The “garbage phases”, α_{j,x,y} can be uncomputed by adding O(W_{ƒ}) extra R_{Z} gates.
When y=0 can be assumed, the initial Quantum Fourier Transform can be replaced by the simpler H^{⊕d} gates, the Quantum Walsh-Hadamard Transform.

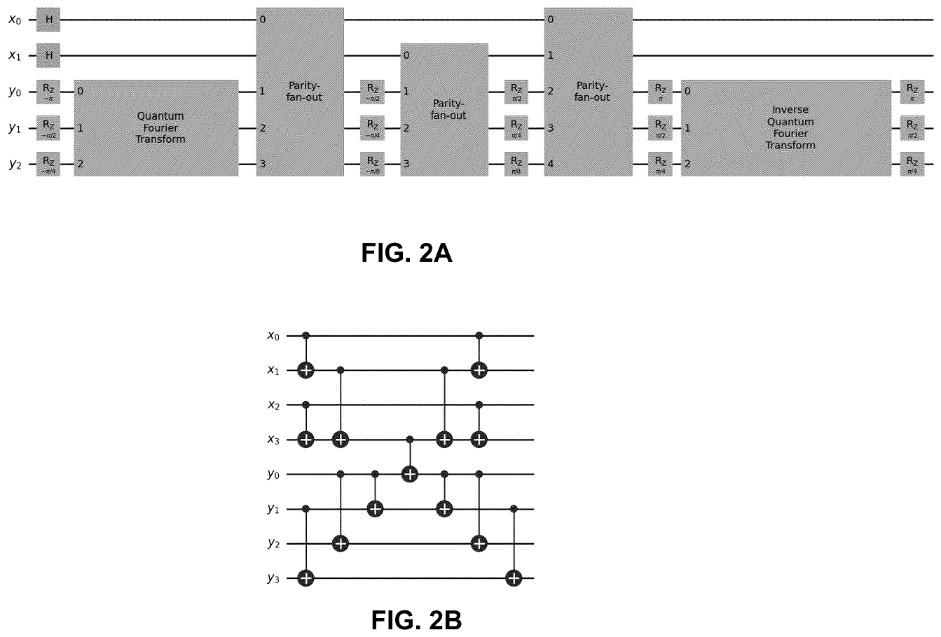

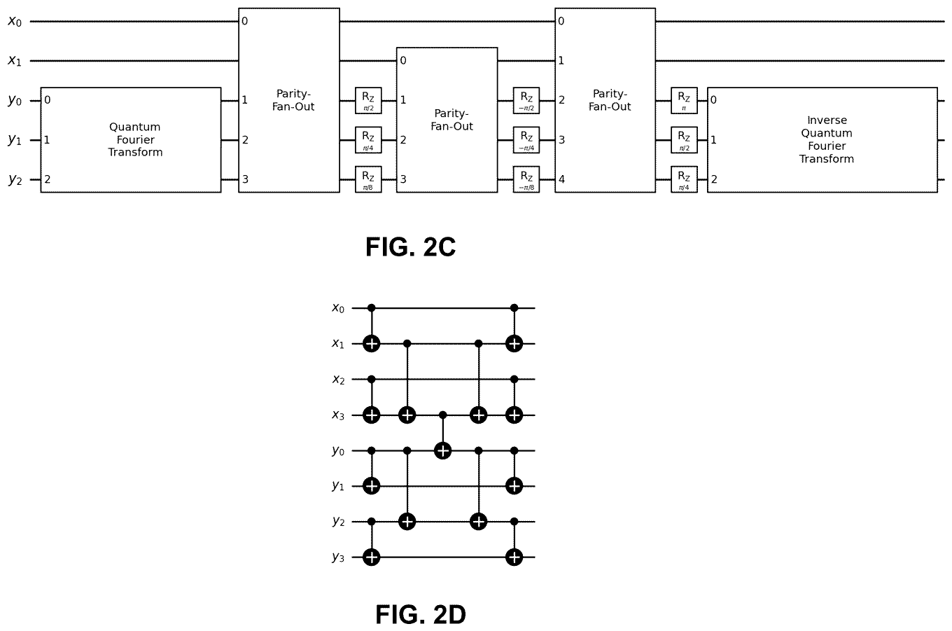

Further examples of quantum oracle 112 are presented in FIGS. 2A and 2C where n=2 and d=3. Further examples of parity-fan-out gates are presented in FIGS. 2B and 2D where n=4 and d=4.

### APPENDIX A, NOTATIONS

We regard elements of [symbol] ₂={0,1} both as booleans and integers (in particular, reals) and use ⊕ to denote addition modulo 2. For binary vectors a,

$$b ∈ {𝔽}_{2}^{n} ,$$

let:
a⊙bϵ [symbol] ₂ be the modulo 2 reduction of the standard inner product of vectors, that is

$$a ⊙ b \tilde{=} {\sum }_{j = 0}^{n - 1} {a}_{j} {b}_{j} mod 2.$$

âϵ[0,2ⁿ)∩ [symbol] be the integer whose binary representation is a, that is

$$\hat{a} := {\sum }_{j = 0}^{n - 1} {a}_{j} {2}^{n - 1 - j} . \qquad ( 3 )$$

We extend the notation in equation (3) to functions and states. More concretely, if

$$f : 𝔽 {}_{2}^{n} \text{?} 𝔽 {}_{2}^{d} ,$$

$$\text{?} \text{indicates text missing or illegible when filed}$$

then

$$\hat{f} : 𝔽 {}_{2}^{n} \text{?} 0 , {2}^{d} ) ⋂ ℤ$$

$$\text{?} \text{indicates text missing or illegible when filed}$$

is defined a

$$\hat{f} ( x ) := ,$$

and if

$$y ∈ 𝔽 {}_{d}^{2} ,$$

then |ŷ [symbol] :=|y [symbol] _{d}. For example, |6 [symbol] =|110 [symbol] ₂=|1 [symbol] |1 [symbol] |0 [symbol] . Finally, we extend the above notation 2^{d}-periodically to all integers. For example, if d=3, then |−2 [symbol] =|−2+2³ [symbol] =|6 [symbol] .

Let

$$WH ( f ) : 𝔽 {}_{2}^{a} \text{?} ℤ$$

$$\text{?} \text{indicates text missing or illegible when filed}$$

be the Walsh-Hadamard Transform of \hat{ƒ}, that is

$$WH ( f ) ( z ) := {\sum }_{\text{?}} \hat{f} ( x ) ( - 1 ) \text{?} , \qquad ( 4 )$$

$$and let$$

$$supp ( WH ( f ) ) := \{ z ∈ 𝔽 {}_{2}^{n} \vert WH ( f ) ( z ) \neq 0 \} .$$

$$\text{?} \text{indicates text missing or illegible when filed}$$

Let h(z)ϵ [symbol] ∩[0,n] be the Hamming weight of the vector

$$z ∈ 𝔽 {}_{2}^{n} ,$$

that is the sum of Its components.

Let H₂(α) be the binary entropy of a number αϵ(0.1), that is

$${H}_{2} ( α ) := - α {log}_{2} ( α ) - ( 1 - α ) {log}_{2} ( 1 - α ) ∈ ( 0 , 1 ) .$$

For each n, kϵZ₊ with k≤n, let

$${B}_{n , k} := {\sum }_{i = 0}^{k} ( \begin{matrix}n \\ k\end{matrix} ) .$$

### For

$$k < \frac{n}{2} .$$

we have

$${B}_{n , k} = O ( {2}^{{H}_{2} ( \begin{matrix}k \\ n\end{matrix} ) n} ) .$$

### APPENDIX B, PARITY-FAN-OUT GATES

Let us define the parity-fan-out gate on k control and d target qubits to act as

$${{{PFO}_{k , d} \vert x 〉}_{k} {{⊗}_{j = 0}}^{d - 1} \vert {y}_{j} 〉 = \vert x 〉}_{k} {{⊗}_{j = 0}}^{d - 1} \vert {y}_{j} ⊕ {x}_{0} ⊕ {x}_{1} ⊕ … ⊕ {x}_{k} 〉 .$$

The parity-fan-out gate can be implemented using on O(k+d) many CNOT gates and with a circuit depth of O(log₂(max(k, d))). When there is only one control qubit, we simply call the above a fan-out gate.

### APPENDIX C, FURTHER ORACLES

Let A_{l,d} be the following oracle:

$${{{{{A \text{?} \vert x 〉}_{l} \vert y )}_{d} ( \vert 0 〉}_{d ( {2}^{i} - 1 )} ) := \vert x 〉}_{l} \vert y 〉}_{d} {⊗}_{\text{?}} {{⊗}^{d - 1} \vert}_{j = 0} {y}_{j} ⊕ ( x ⊙ z ) 〉 . \qquad ( 5 )$$

$$\text{?} \text{indicates text missing or illegible when filed}$$

The above gate can be implemented using on O(d2^{l}) many CNOT gates and with a circuit depth of O(l+logₗ(d)).

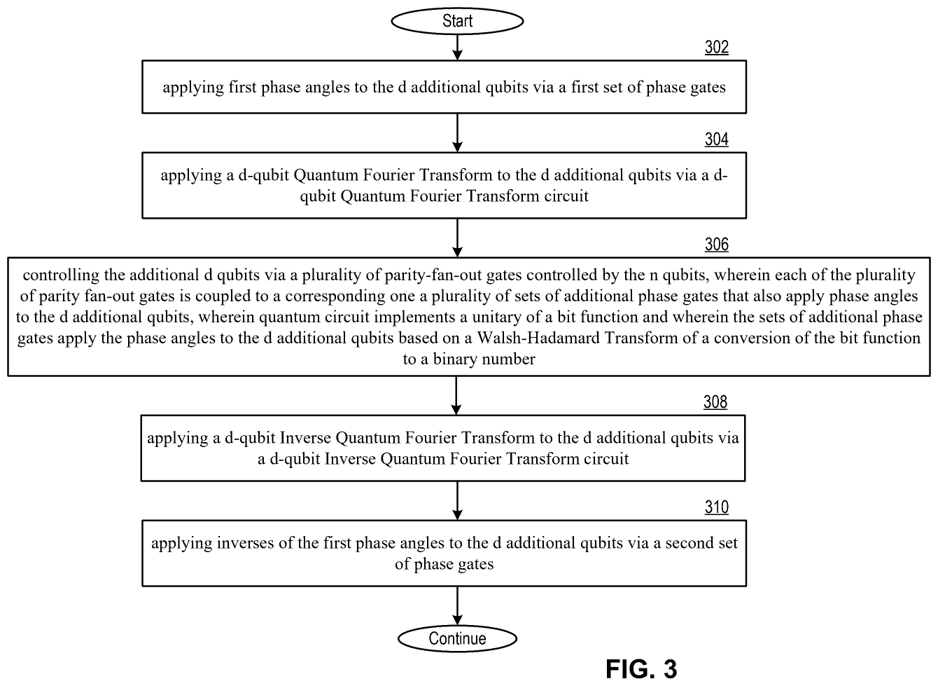

FIG. 3 is a flow diagram of an example method. In particular, a method is presented for use in a quantum circuit configured to process n qubits and d additional qubits and furthermore for use with one or more functions and features described in conjunctions with FIGS. 1A, 1B, 2A, 2B and the further descriptions above. Step 302 includes applying first phase angles to the d additional qubits via a first set of phase gates. Step 304 includes applying a d-qubit Quantum Fourier Transform to the d additional qubits via a d-qubit Quantum Fourier Transform circuit. Step 306 includes controlling the additional d qubits via a plurality of parity-fan-out gates controlled by the n qubits, wherein each of the plurality of parity fan-out gates is coupled to a corresponding one a plurality of sets of additional phase gates that also apply phase angles to the d additional qubits, wherein quantum circuit implements a unitary of a bit function and wherein the sets of additional phase gates apply the phase angles to the d additional qubits based on a Walsh-Hadamard Transform of a conversion of the bit function to a binary number. Step 308 includes applying a d-qubit Inverse Quantum Fourier Transform to the d additional qubits via a d-qubit Inverse Quantum Fourier Transform circuit.

In addition or in the alternative to any of the foregoing, the method further includes Step 310 of applying inverses of the first phase angles to the d additional qubits via a second set of phase gates. Furthermore, Step 302 may or may not be included, depending on the inclusion or exclusion of step 310.

In addition or in the alternative to any of the foregoing, the quantum circuit implements one of: a quantum dictionary encoder, a data-access oracle, a projective quantum dictionary encoder or a projective data-access oracle.

In addition or in the alternative to any of the foregoing, the first phase angles applied to the d additional qubits each correspond to a phase angle of −π/2^{j} for a jth one of the d additional qubits.

In addition or in the alternative to any of the foregoing, the plurality of parity-fan-out gates are each fan-out gates controlled by differing ones of the n qubits.

In addition or in the alternative to any of the foregoing, the plurality of parity-fan-out gates are each controlled by differing non-null subsets of the n qubits.

In addition or in the alternative to any of the foregoing, when one of the parity-fan-out gates is controlled by k of the n qubits, the one of the plurality of parity-fan-out gates is implemented using O(k+d) CNOT gates.

In addition or in the alternative to any of the foregoing, the conversion of the bit function to the binary number utilizes a modulo 2 addition.

In addition or in the alternative to any of the foregoing, the conversion of the bit function to the binary number utilizes a polynomial approximation of the bit function.

In addition or in the alternative to any of the foregoing, the quantum circuit is implemented without ancillas.

In addition or in the alternative to any of the foregoing, the quantum circuit is implemented via a plurality of ancillas initialized to a zero state.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A quantum circuit, configured to process n qubits and d additional qubits, the quantum circuit comprising:
a d-qubit Quantum Fourier Transform circuit configured to apply a d-qubit Quantum Fourier Transform to the d additional qubits;
a plurality of parity-fan-out gates controlled by the n qubits and configured to control the additional d qubits, wherein each of the plurality of parity fan-out gates is coupled to a corresponding one a plurality of sets of additional phase gates that also apply phase angles to the d additional qubits, wherein quantum circuit implements a unitary of a bit function and wherein the sets of additional phase gates apply the phase angles to the d additional qubits based on a Walsh-Hadamard Transform of a conversion of the bit function to a binary number, and
a d-qubit Inverse Quantum Fourier Transform circuit configured to apply a d-qubit Inverse Quantum Fourier Transform to the d additional qubits.

2. The quantum circuit of claim 1, wherein the quantum circuit further includes:
a first set of phase gates configured to apply, prior to the d-qubit Quantum Fourier Transform circuit, first phase angles to the d additional qubits; and
a second set of phase gates configured to apply, after the d-qubit Inverse Quantum Fourier Transform circuit, inverses of the first phase angles.

3. The quantum circuit of claim 1, wherein the quantum circuit implements one of: a quantum dictionary encoder, a data-access oracle, a projective quantum dictionary encoder or a projective data-access oracle.

4. The quantum circuit of claim 1, wherein the first phase angles applied to the d additional qubits each correspond to a phase angle of −π/2^{j} for a jth one of the d additional qubits.

5. The quantum circuit of claim 1, wherein the plurality of parity-fan-out gates are each fan-out gates controlled by differing ones of the n qubits.

6. The quantum circuit of claim 1, wherein the plurality of parity-fan-out gates are each controlled by differing non-null subsets of the n qubits.

7. The quantum circuit of claim 1, wherein, when one of the parity-fan-out gates is controlled by k of the n qubits, the one of the plurality of parity-fan-out gates is implemented using O(k+d) CNOT gates.

8. The quantum circuit of claim 1, wherein the conversion of the bit function to the binary number utilizes a modulo 2 addition.

9. The quantum circuit of claim 1, wherein the conversion of the bit function to the binary number utilizes a polynomial approximation of the bit function.

10. The quantum circuit of claim 1, wherein the quantum circuit is implemented without ancillas.

11. A method for use in a quantum circuit configured to process n qubits and d additional qubits, the method comprising:
applying a d-qubit Quantum Fourier Transform to the d additional qubits via a d-qubit Quantum Fourier Transform circuit;
controlling the additional d qubits via a plurality of parity-fan-out gates controlled by the n qubits, wherein each of the plurality of parity fan-out gates is coupled to a corresponding one a plurality of sets of additional phase gates that also apply phase angles to the d additional qubits, wherein quantum circuit implements a unitary of a bit function and wherein the sets of additional phase gates apply the phase angles to the d additional qubits based on a Walsh-Hadamard Transform of a conversion of the bit function to a binary number, and
applying a d-qubit Inverse Quantum Fourier Transform to the d additional qubits via a d-qubit Inverse Quantum Fourier Transform circuit.

12. The method of claim 11, further comprising:
applying, prior to the d-qubit Quantum Fourier Transform, first phase angles to the d additional qubits via a first set of phase gates; and
applying, after the d-qubit Inverse Quantum Fourier Transform, inverses of the first phase angles to the d additional qubits via a second set of phase gates.

13. The method of claim 11, wherein the quantum circuit implements one of: a quantum dictionary encoder, a data-access oracle, a projective quantum dictionary encoder or a projective data-access oracle.

14. The method of claim 11, wherein the first phase angles applied to the d additional qubits each correspond to a phase angle of −π/2^{j} for a jth one of the d additional qubits.

15. The method of claim 11, wherein the plurality of parity-fan-out gates are each fan-out gates controlled by differing ones of the n qubits.

16. The method of claim 11, wherein the plurality of parity-fan-out gates are each controlled by differing non-null subsets of the n qubits.

17. The method of claim 11, wherein, when one of the parity-fan-out gates is controlled by k of the n qubits, the one of the plurality of parity-fan-out gates is implemented using O(k+d) CNOT gates.

18. The method of claim 11, wherein the conversion of the bit function to the binary number utilizes a modulo 2 addition.

19. The method of claim 11, wherein the conversion of the bit function to the binary number utilizes a polynomial approximation of the bit function.

20. The method of claim 11, wherein the quantum circuit is implemented without ancillas.
